(19) United States
(12) Patent Application Publication
(10) Pub. No.: US 2026/0234898 A1
(43) Pub. Date: Aug. 13, 2026

(54) ATTACHMENT FOR A WORKING MACHINE

(71) Applicants: Deere & Company, Moline, IL (US); HAMM AG, Tirschenreuth (DE)

(72) Inventors: BRETT S. GRAHAM, Dubuque, IA (US); ARUN M. NARAYANAN, Pune (IN); Arun Pandian MURUGESAN, Pune (IN); Mark A. Simon, Dubuque, IA (US); Stefan Bäuml, Tirschenreuth (DE)

(21) Appl. No.: 19/047,888

(22) Filed: Feb. 7, 2025

(51) Int. Cl. E02F 3/96

(52) U.S. Cl. CPC E02F 3/961

(57) ABSTRACT

Disclosed herein are examples of tool assemblies for a work vehicle. The tool assemblies comprise a roller and a blade assembly, which may be attached to a common frame that connects the tool assembly to the work vehicle. The roller may comprise a smooth or textured roller and may be detachable from the frame. The blade assembly may be detachable from the frame and movable between two or more positions relative to the frame such that a distance between the blade assembly and a work surface can be adjusted. In some examples, the tool assemblies further comprise a position indicator to inform an operator of the relative position between the blade assembly and the frame. In some examples, the tool assemblies further comprise one or more features to prevent the tilt of the tool assembly relative to the work vehicle.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD

The present disclosure concerns attachments for a working machine, the attachments having a tool assembly comprising a roller and a detachable and adjustable grading blade.

### BACKGROUND

To prepare a worksite for a compacting operation, it is frequently necessary to first prepare the worksite by grading the material to be compacted. This is frequently done using a work vehicle equipped with a blade suitable for redistributing a granular material to a desired height. Once the granular material is at a desired height, it can be compacted with a roller as desired.

To reduce the number of working vehicles and vehicle operations required to finish a compacting job, a roller can be combined with a grading blade that progresses over the ground in advance of the roller. In this way, the grading blade can be used to redistribute granular material to a desired height before it is compacted without the need for separate vehicles to grade and compact a worksite.

However, the required spacing between a grading blade and the work surface, such as the ground and/or granular material to be compacted, will vary based on the specific details of any compacting job to be performed. As such, even when a vibratory roller is combined with a knockdown blade in a single tool package, this tool package may not be suitable for a broad range of jobs and may not be adaptable to fit a variety of working conditions.

Therefore, there is a continuing need for improvements on such tool assemblies for a work vehicle.

### BRIEF SUMMARY

Disclosed herein are examples of attachments for a work vehicle. Particularly, the attachments disclosed herein are tool assemblies configured to be attached to a work vehicle and comprising a roller and a blade assembly. The blade assembly and roller can, in some examples, be attached to a common housing or frame that connects the tool assembly to the work vehicle. The blade assemblies used in the tool assemblies herein are detachable from the common housing or frame and can be adjustably positioned such that a spacing between the blade assembly and the ground can be varied according to the needs of a grading and compacting operation.

Certain examples concern a tool assembly for a work vehicle comprising a tool frame, a roller rotationally mounted to the tool frame for compacting a granular material, and a blade assembly. The blade assembly includes a blade edge and is adjustably attached to the tool frame and pivotable around a pivot between a first configuration and a second configuration. When the blade assembly is in the first configuration, the blade edge is positioned a height relative to the ground and when the blade assembly is in the second configuration, the blade edge is positioned a second height relative to the ground, wherein the second height is greater than the first height.

Certain examples concern a method for a grading operation at a work site using a work vehicle including a tool assembly. The tool assembly has a roller and a blade assembly. The blade assembly is movable between a first configuration, a second configuration, and a third configuration. The method comprises identifying a desired grade finish for the grading operation and selecting between a smooth drum roller and a padfoot drum roller based on the desired grade finish for the grading operation. The method also comprises selecting between the first configuration, the second configuration, and the third configuration for the blade assembly depending on the desired grade finish and the drum roller selected and operating the work vehicle at the work site to grade the ground according to the desired grade finish for the grading operation.

Certain examples concern a work vehicle comprising a tool assembly. The tool assembly includes a tool frame, a roller rotatably mounted to the tool frame, and a blade assembly including a blade edge and being adjustably attached to the tool frame. The blade assembly is rotatable around a pivot between a first configuration, a second configuration, and a third configuration. The tool assembly also includes a locking mechanism configured to secure the blade assembly in the first configuration, the second configuration, or the third configuration. The blade edge extends at an angle relative to the ground. When the blade assembly is in the first configuration, the angle has a first value, when the blade assembly is in the second configuration, the angle has a second value, and when the blade assembly is in the third configuration, the angle has a third value. The second value is greater than the first value and the third value is greater than the second value.

Numerous objects, features, and advantages of the embodiments set forth herein will be readily apparent to those skilled in the art upon reading the following disclosure in conjunction with the accompanying drawings.

### BRIEF DESCRIPTION OF THE DRAWINGS

FIG. 1 is a front perspective view of a work vehicle including a work tool attachment according to one aspect of the present disclosure.

FIG. 2A is a front perspective view of the work tool attachment of FIG. 1.

FIG. 2B is an exploded view of the work tool attachment of FIG. 1

FIG. 3A is a side view of the work tool attachment of FIG. 1 in a first configuration.

FIG. 3B is a side view of the work tool attachment of FIG. 1 in a second configuration.

FIG. 4A is an enlarged top perspective view of the tool attachment of FIG. 1.

FIG. 4B. is an enlarged side perspective view of the tool attachment of FIG. 1.

FIG. 5A is a rear perspective view of the tool attachment of FIG. 1.

FIG. 5B is a rear view of the tool attachment of FIG. 1 in a tilted configuration.

FIG. 5C is an enlarged rear perspective view of a portion of the tool attachment of FIG. 1.

FIG. 6 is a flowchart of a surface grading method according to one aspect of the present disclosure.

### DETAILED DESCRIPTION OF THE INVENTION

### General Terms

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

As used herein, the terms proximal and distal refer to direction along an attached object having a free end, relative to the point of attachment. Particularly, when an object is attached at one end, the end of the attachment is the proximal end, and the free end is the distal end. The direction along the object towards the point of attachment is the proximal direction. The direction along the object towards the free end is the distal direction.

As used herein in conjunction with numerical quantities or ranges, the term “about” is used to describe unintentional or inadvertent deviations from an intended quantity or range that nonetheless do not significantly affect the function, behavior, or property of the device or method described, such as may arise from machine tolerance, user variance, or external limitations on measurement accuracy.

Unless explained otherwise, all technical and scientific terms used herein have the same meaning as commonly understood to one of ordinary skill in the art to which this disclosure belongs. Although methods and compounds similar or equivalent to those described herein can be used in the practice or testing of the present disclosure, suitable methods and compounds are described below. The compounds, methods, and examples are illustrative only and not intended to be limiting, unless otherwise indicated. Other features of the disclosure are apparent from the following detailed description and the claims.

Unless otherwise indicated, all numbers expressing quantities of components, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing embodiments from discussed prior art, the embodiment numbers are not approximates unless the word “about” is recited. Furthermore, not all alternatives recited herein are equivalents.

### Introduction to the Disclosed Technology

The present disclosure concerns tool assemblies, and particularly tool assemblies comprising an adjustable knockdown blade for use with work vehicles in grading operations. Generally, the tool assemblies disclosed herein are configured to releasably attach to a work vehicle.

The tool assemblies disclosed herein generally comprise a tool frame that connects to the work vehicle and a roller rotatably attached to the structural member. The roller may be a smooth drum roller or a padfoot drum roller. The tool assemblies disclosed herein also generally include a removable blade assembly, such as a removable knockdown blade, attached to the tool frame. In some examples, the blade assembly may be adjustably positionable such that the spacing between the blade assembly and the ground can be altered, preferably without fully detaching the blade assembly from the tool frame.

The tool assemblies disclosed herein may also include one or more features configured to lock the tilt (that is, the vertical rotation) of the roller relative to the working vehicle with which the tool assembly is used.

Advantageously, the tool assemblies disclose herein allow for a grading operation and a compaction operation to be combined, and for a vehicle operator to select both the desired grading performed by the detachable and adjustable blade, and the finish and degree of compaction in the compaction operation performed by the roller.

### Aspects of the Disclosed Technology

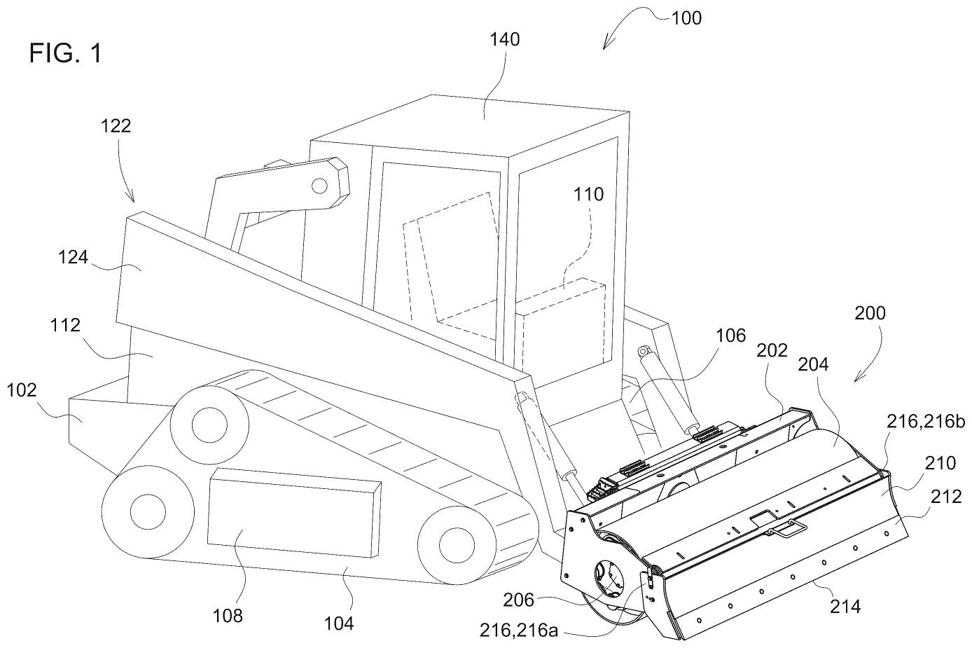

Referring now to the drawings, FIG. 1 depicts an example work vehicle 100. According to one aspect of the present disclosure, the work vehicle 100 can be a vehicle such as the track crawler shown in FIG. 1, but it will be appreciated that the tool assemblies disclosed herein can be used with other work vehicles.

The work vehicle 100 includes an undercarriage 102 having first and second ground engaging units 104 and 106 (for example, crawler tracks) including first and second hydraulic travel motors 108 for driving the first and second ground engaging units 104 and 106, respectively. As seen in FIG. 1, a main frame 112 is supported by the undercarriage 102. According to some aspects of the present disclosure, the first and second ground engaging units 104 and 106 may be left and right crawler tracks, respectively, as shown in FIG. 1.

According to one aspect of the present disclosure, the work vehicle 100 includes a working assembly 122 extending alongside and forward from the main frame 112. The working assembly 122 includes one or more actuators 124 extending between the main frame 112 and a working tool, such as the tool assembly described in greater detail below.

An operator cab 140 may be located on the main frame 112, as illustrated in FIG. 1. The operator cab 140 and the working assembly 122 may both be mounted on the main frame so that the operator cab 140 faces in a working direction of the work vehicle 100, such as in the direction of the working tool described in greater detail below. A control station 110 may be located in the operator cab 140.

According to one aspect of the present disclosure, a working tool, such as tool assembly 200 can be mounted to work vehicle 100, for example at a distal end portion of the one or more actuators 124, as shown in FIG. 1.

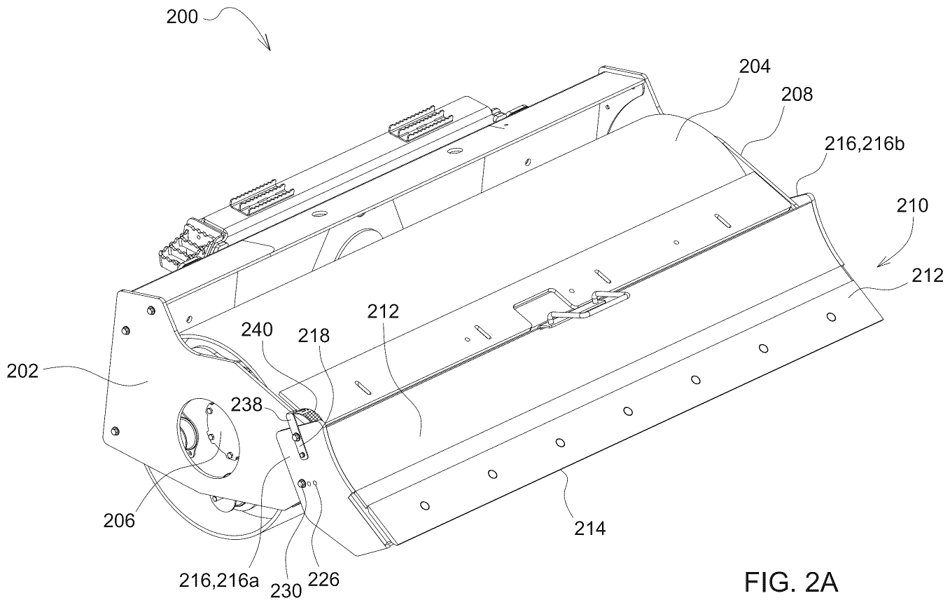

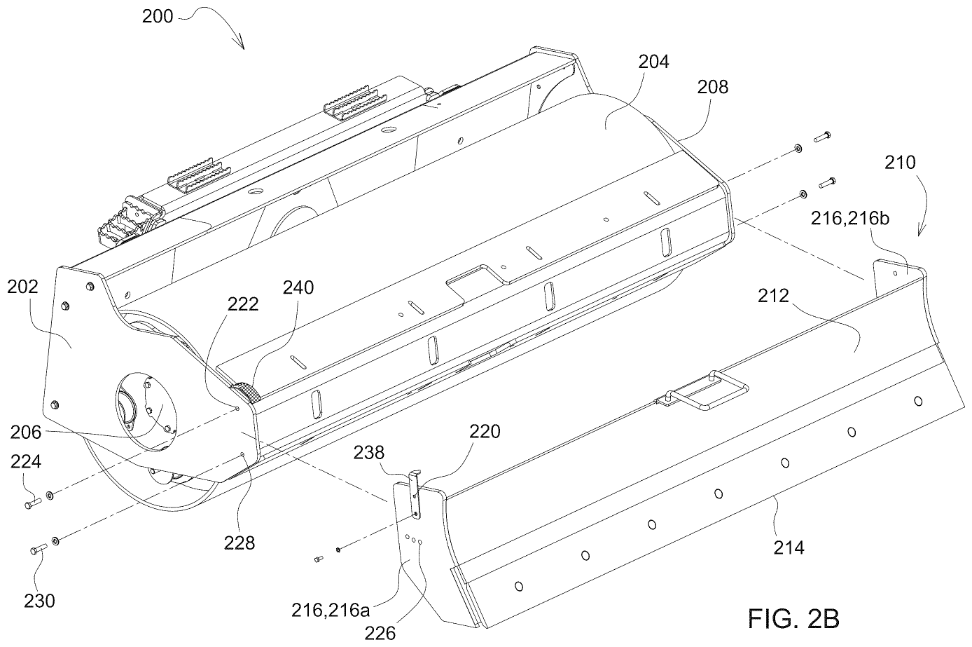

Turning now to FIGS. 2A and 2B, the tool assembly 200 can include a tool frame 202, which is configured to be releasably attached to the work vehicle 100, as shown in FIG. 1. The tool assembly 200 can also include a roller 204 mounted to the tool frame 202. The roller 204 can be rotatably connected to the tool frame 202. For example, as shown in FIGS. 2A and 2B, the roller 204 can be attached to the tool frame 202 at a first end portion 206 and a second end portion 208. The first end portion 206 and the second end portion 208 can each comprise an axle that is received by the tool frame 202 such that the roller 204 is rotatably movable relative to and within the tool frame 202.

The roller 204 can be used in work operations involving the compaction of granular materials, such as soil or gravel. It will be appreciated that the roller 204 can have a surface geometry tailored for a specific compaction operation. For example, in some operations, a comparatively greater degree of compaction is required, but a comparatively rougher finish can be tolerated. In such operations, the roller 204 can be a textured roller, sometimes referred to as a “padfoot” roller. In other operations, a comparatively lesser degree of compaction is required, but a comparatively finer finish is also required. In such operations, the roller 204 can have a smooth rolling surface. According to some aspects of the present disclosure, the roller 204 may be removably mounted to the tool frame 202, such that a roller 204 of one surface geometry may be replaced by a roller 204 of an alternate surface geometry, depending on the requirements of a given work operation, such as a compacting job.

The tool assembly 200 can also include a blade assembly 210, which is adjustably mounted to the tool frame 202, as shown in FIGS. 2A and 2B. The blade assembly 210 comprises a blade 212 with a blade edge 214 configured to selectively engage the ground, such as the ground at a working site. Advantageously, because the tool assembly 200 includes a blade assembly 210 positioned ahead of the roller 204 in the driving direction of the work vehicle 100, the blade assembly 210 can be used to prepare the ground for a work operation, such as a roller compaction. Specifically, the blade assembly 210 can be used to grade a granular material (for example, soil or gravel) in preparation for rolling.

According to some aspects of the present disclosure, the blade assembly 210 also includes one or more mounting members 216, such as a first mounting member 216a and a second mounting member 216b, as shown in FIGS. 2A and 2B. The mounting members 216 can include mounting features 218, such as an adjustable connector located on the first mounting member 216a and/or the second mounting member 216b, as shown in FIGS. 2A and 2B. The mounting features 218 can, in such examples, be configured to releasably attach the blade assembly 210 to the tool frame 202, as shown in FIG. 2B.

In some examples, such as that illustrated in FIG. 2A, the mounting features 218 can include pivot aperture 220 corresponding to and extending through one of the mounting members 216 (such as the first mounting member 216a or the second mounting member 216b shown in FIGS. 2A and 2B). In such examples, the tool frame 202 can also include a corresponding tool frame aperture 222 that is configured to align with the pivot aperture 220, as shown in FIGS. 2A and 2B. The pivot aperture 220 and the corresponding tool frame aperture 222 may be configured to receive a pivot element 224, as shown in FIG. 2B. In such examples, the pivot element 224 can secure the one or more mounting members 216 (and therefore the blade assembly 210) to the tool frame 202, in a hinged or pivotable fashion, as shown in FIG. 2B, such that the blade assembly 210 can be rotated about the pivot element 224 (such as a bolt or pin) extending through the pivot aperture 220 and the corresponding tool frame aperture 222 to adjust the position of the blade assembly 210 relative to the tool frame 202. It will be appreciated that, in some examples, each side of the tool assembly 200 can include a paired pivot aperture 220 and tool frame aperture 222, such that the blade assembly 210 is pivotally attached to the tool frame 202 at both of the mounting members 216 (that is, the first mounting member 216a and the second mounting member 216b shown in FIGS. 2A and 2B).

According to some aspects of the present disclosure, the mounting features 218 can also include a plurality of adjustment apertures 226 extending through the one or more mounting members 216 (such as the first mounting member 216a and the second mounting member 216b shown in FIGS. 2A and 2B). In some examples, such that that illustrated in FIGS. 2A and 2B, the plurality of adjustment apertures 226 can be longitudinally spaced apart from each other (that is, spaced apart in the driving direction of the work vehicle 100), and arranged in an arc.

A corresponding locking aperture 228 can extend through a side portion of the tool frame 202, as shown in FIG. 2B. The locking aperture 228 can be configured to align with one of the plurality of adjustment apertures 226 such that a locking element 230 (for example, a bolt or a pin) can extend simultaneously through one of the adjustment apertures 226 and the locking aperture 228 to retain the blade assembly in any one of the configurations corresponding to the plurality of adjustment apertures 226. In examples in which the plurality of adjustment apertures 226 is arranged in a longitudinally spaced arc, said arc can correspond to the rotational arc of the blade assembly 210 as it rotationally pivots relative to the tool frame 202 around the pivot element 224, such that each adjustment aperture 226 of the plurality of adjustment apertures 226 will align with the locking aperture 228 at a different rotational position of the blade assembly 210 relative to the tool frame 202.

It will be appreciated that, while specific reference has been made to FIGS. 2A and 2B showing a locking mechanism comprising a locking aperture 228 extending through a side portion of the tool frame 202, other locking mechanisms may be suitable for securing the blade assembly 210 in a chosen rotational position relative to the tool frame 202. For example, in lieu of a pin extending through both an adjustment aperture 226 and the locking aperture 228, the tool assembly 200 can include a fixed or retractable pin attached to the side portion of the tool frame 202. In such examples, the blade assembly 210 can be pivoted around the pivot element 224 until an adjustment aperture 226 aligns with the fixed or retractable pin, which can then extend through the adjustment aperture 226 to secure the blade assembly 210 in place relative to the tool frame 202.

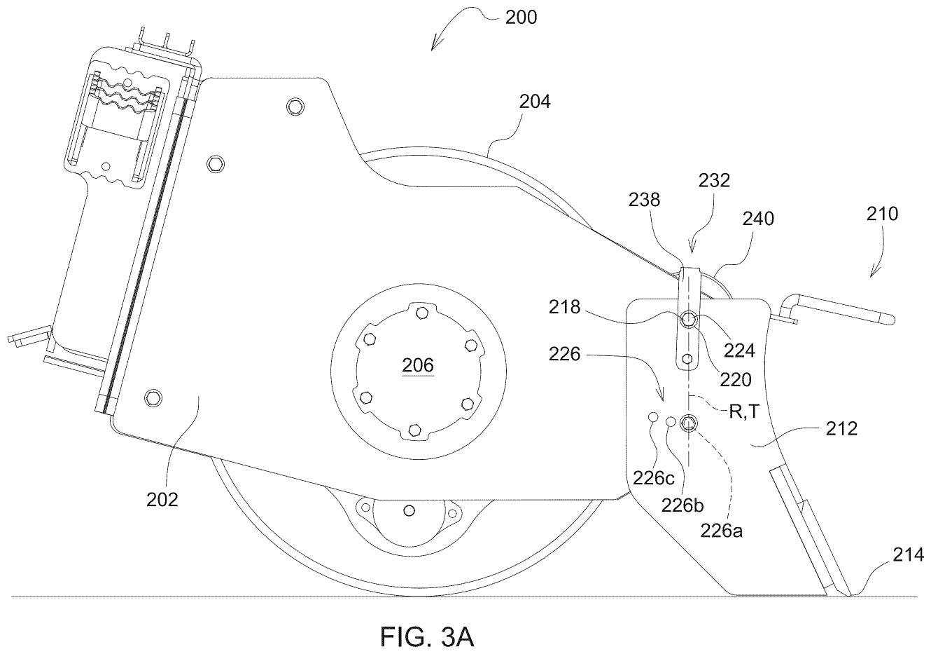

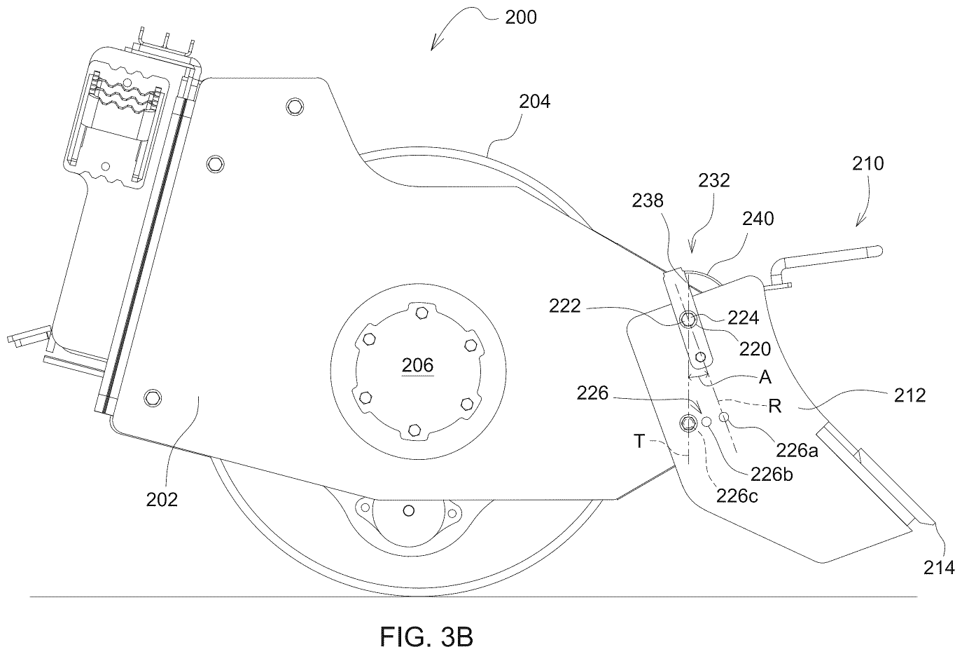

According to one aspect of the present disclosure, by including a varying number of adjustment apertures 226 in the plurality of locking apertures 226, a varying number of lockable positions for the blade assembly 210 relative to the tool frame 202 can be provided. For example, as illustrated in FIGS. 2A through 3B, the plurality of adjustment apertures 226 can include three locking apertures 226 longitudinally spaced apart in an arc. In such an example, the blade assembly 210 can be adjusted between a first position, a second position, and a third position. More particularly, when the forwardmost adjustment aperture 226 (for example, first adjustment aperture 226a as shown in FIGS. 3A and 3B) is aligned with the locking aperture 228, the blade assembly 210 is in the first position and can be locked into the first position by introducing the locking element 230 through the first adjustment aperture 226a and the locking aperture 228. Similarly, when the next forwardmost adjustment aperture 226 (for example, second adjustment aperture 226b shown in FIGS. 3A and 3B) is aligned with the locking aperture 228, the blade assembly 210 is in the second position and can be locked into the second position by introducing the locking element 230 through the second adjustment aperture 226b and the locking aperture 228. Likewise, when the rearmost adjustment aperture 226 (that is, third adjustment aperture 226c shown in FIGS. 3A and 3B) is aligned with the locking aperture 228, the blade assembly 210 is in the third position and can be locked into the third position by introducing the locking element 230 through the third adjustment aperture 226c and the locking aperture 228.

It will be appreciated that, while FIGS. 2A through 3B show the blade assembly 210 having three adjustment apertures 226 longitudinally spaced apart from each other and arranged along an arc, a different number of adjustment apertures 226, such as two, four, or more than four adjustment apertures 226 can be included, and similarly longitudinally spaced apart from each other and arranged along the arc. It will be similarly appreciated that in examples having a differing number of adjustment apertures 226, the blade assembly 210 can be arranged in a correspondingly different number of positions, such as two, four, or more than four positions, depending on the number of adjustment apertures 226 included.

Advantageously, because the blade assembly 210 is positioned ahead of the roller 204 in the driving direction of the work vehicle 100, the blade assembly 210 will engage the ground, and particularly the granular material to be compacted by the roller 204 before the roller 204 engages the granular material to compact it. In turn, this allows the blade assembly 210 to be used to adjust the height of the work surface (that is, the height of the granular material to be compacted) before the roller 204 engages the work surface. In turn, this allows for the tool assembly 200 described herein to be used to accomplish both a pre-compaction grading operation and a compaction operation.

It will be appreciated that because the blade assembly 210 is rotationally mounted to the tool frame 202, and movable between a plurality of positions, as previously discussed, it is possible to adjust the height of the blade edge 214 relative to the ground, such as the ground at a worksite, allowing a use of a work vehicle 100 having the tool assembly 200 mounted thereto to select the height of the blade assembly 210 relative to the ground for a pre-compaction grading operation.

According to some aspects of the present disclosure, the tool assembly 200 may further include one or more indicator features to assist a user of the work vehicle 100 with the tool assembly 200 mounted thereto in selecting the appropriate height of the blade assembly 210 relative to the ground, as previously discussed.

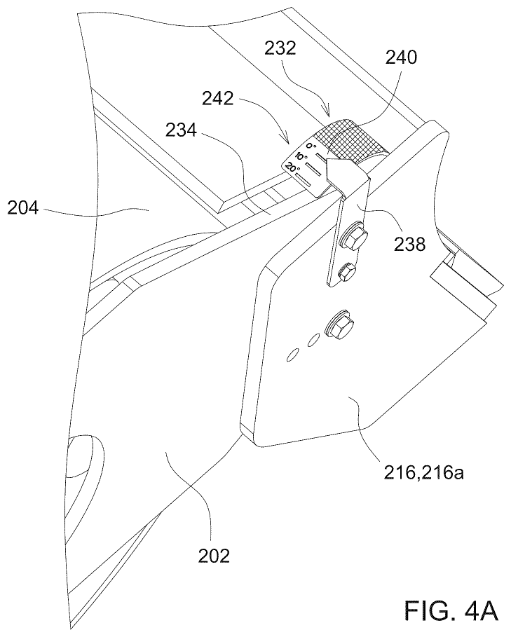

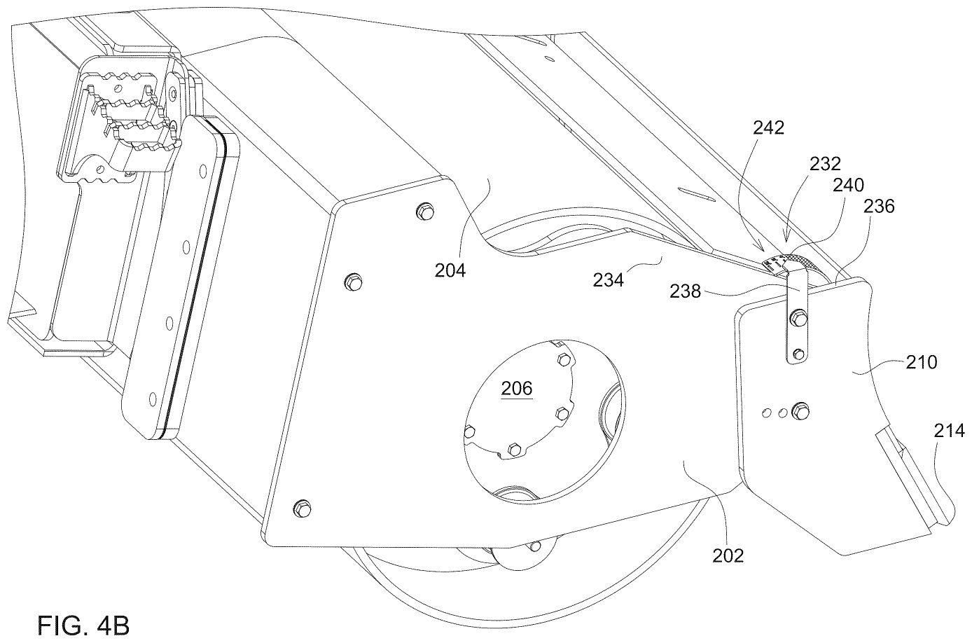

For example, as shown in FIGS. 4A and 4B, the tool assembly 200 can include a position indicator assembly 232. The position indicator assembly 232 can be mounted to a top portion 234 of the tool frame 202 or a top portion 236 of the blade assembly 210, such that the position indicator assembly 232 is visible from the operator cab 140 of the work vehicle 100 and can thus be seen by the operator while the work vehicle 100 with the tool assembly 200 mounted thereto is in use.

According to some aspects of the present disclosure, the position indicator assembly 232 can include an indicator arm 238 mounted to the blade assembly 210 and a position gauge 240 mounted to the tool frame 202. In such examples, because the indicator arm 238 is mounted to the blade assembly 210, as the blade assembly 210 is rotated around the pivot element 224 (for example, between the first position, the second position, the third position, or any other position in which the blade assembly 210 can be locked), the indicator arm 238 moves accordingly with the blade assembly 210 to a corresponding number of indicator positions.

Because the position gauge 240 is mounted to the tool frame 202 in examples such as that illustrated in FIGS. 4A and 4B, it remains static relative to the tool frame 202 while the indicator arm 238 moves between the various indicator positions previously discussed. Accordingly, the position gauge 240 can include a plurality of position markers 242, such as those shown along the top portion of the position gauge 240 in FIGS. 4A and 4B. The position markers 242 can be spaced apart from each other such that each position marker is configured to correspond with one of the indicator positions previously discussed, such that the position marker indicates to the operator of the work vehicle 100 which position the blade assembly 210 is in.

According to one aspect of the present disclosure, the positions can be defined as a function of an angle A (in some instances referred to as a tilt angle) between a reference axis R and a tilt axis T, as shown in FIGS. 3A and 3B. In such examples, the reference axis R is defined by a line extending between the pivot aperture 220 and the first adjustment aperture 226a. Similarly, the tilt axis T can be defined by a line extending between the pivot aperture 220 and the locking element 230 (or alternatively, between the pivot aperture 220 and the adjustment aperture 228 that is receiving the locking element 230).

Thus, when the blade assembly 210 is in the first position (and thus the locking element 230 extends through the first adjustment aperture 226a), the angle A between the reference axis R and the tilt axis T is 0 degrees, or about 0 degrees (for example, from 0 degrees to 1 degree). Similarly, when the blade assembly 210 is in the second position (and thus the locking element 230 extends through the second adjustment aperture 226b), the angle A between the reference axis R and the tilt axis T is a value larger than about 0 degrees. Likewise, when the blade assembly 210 is in the third position (and this the locking element 230 extends through the third adjustment aperture 226c), the angle A between the reference axis R and the tilt axis T is a value larger than the first value.

It will be readily appreciated that the plurality of adjustment apertures 226 can be spaced apart such that the angle A between the reference axis R and the tilt axis T at each position corresponds to a known value. For example, as illustrated in FIGS. 4A and 4B, the angle A is 0 degrees or about 0 degrees (for example, from 0 degrees to 1 degree) when the blade assembly 210 is in the first position, 10 degrees or about 10 degrees (for example, from 9 degrees to 11 degrees) when the blade assembly 210 is in the second position, and 20 degrees or about 20 degrees (for example, from 19 degrees to 21 degrees) when the blade assembly 210 is in the third position. It will be understood, however, that in other examples, a different number of positions may be provided, and it will also be understood that the angle A between the reference axis R and the tilt axis T can have different values associated with one or more of the recited positions, and/or any additional positions provided by the positioning of the adjustment apertures 226.

It will also be understood that, while the examples discussed herein and shown, particularly in FIGS. 4A and 4B, show a position indicator assembly 232 having the indicator arm 238 mounted to and moving along with the blade assembly 210, and a position gauge 240 mounted to and stationary relative to the tool frame 202, other configurations for the position indicator assembly 232 are possible. For example, the indicator arm 238 could be mounted to and thus stationary relative to the tool frame 202, and the position gauge 240 could be mounted to and thus movable along with the blade assembly 210.

According to some aspects of the present disclosure, the tool assembly 200 is designed to selectively tilt laterally (that is, on the left hand and right hand sides). In such examples, the tool assembly 200 can be adjustably secured to the work vehicle 100 such that the tool assembly 200 is movable between a locked configuration and a tiltable configuration. In the tiltable configuration, the tool assembly 200 can be allowed to laterally tilt, such that the left end and right end of the tool assembly 200 move vertically relative to the work vehicle 100, to allow for adjustment of the position of the tool assembly 200 in a vertical plane. Advantageously, this allows the tool assembly 200 to be positioned at a tilt relative to the ground at a worksite. In some examples, the tool assembly 200 can be locked at a single desired tilt for a work operation, and in others, the tool assembly 200 can be left in the adjustable configuration for adaptive engagement with uneven terrain.

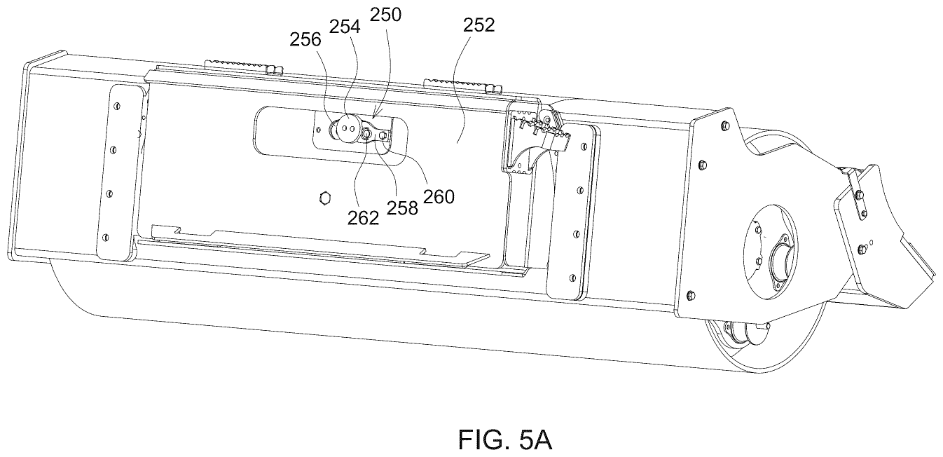

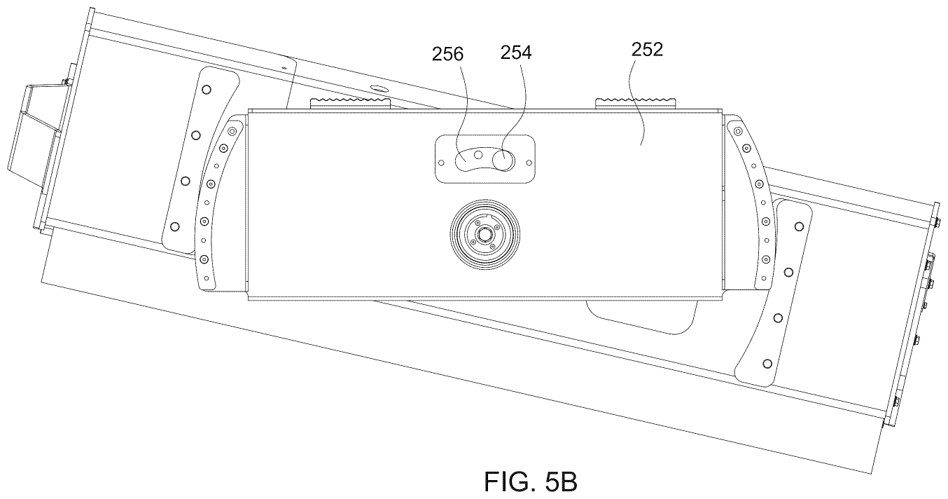

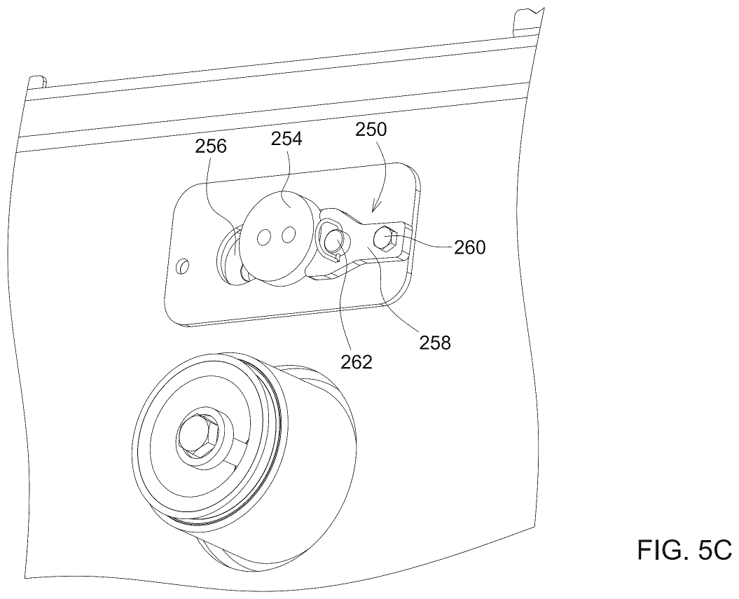

According to some aspects of the present disclosure, the tool assembly 200 disclosed herein can also include a tilt mechanism that includes a lock suck as tilt locking latch 250, as illustrated in FIGS. 5A-5C. For example, as shown in FIG. 5A, the tool assembly 200 can be mounted to the work vehicle 100 by a tilt mount 252 that is disposed between the tool frame 202 and the work vehicle 100. For example, as shown in FIG. 5A, the tool assembly 200 may include a mounting post 254 that extends through both the tilt mount 252 and the tool frame 202. In some examples, the locking post 254 can be received in a corresponding aperture in the tool frame 202 and can extend through a tilt track 256 that extends laterally around the mounting post 254, thus allowing the mounting post 254 to laterally traverse the tilt track 256 as the tool frame 202 rotates relative to the tilt mount 252.

The tilt mount 252 can thus be configured to allow the tool assembly 200 to rotate in a vertical plane relative to the work vehicle 100, which advantageously allows the work vehicle 100 with the tool assembly 200 to perform work operations, such as compaction of granular material, where a grade is required at the worksite. However, once the tool assembly 200 has been placed at a desired tilt (that is, the desired rotational position within the vertical plane relative to the work vehicle 100), it may not be desirable for the tool assembly 200 to rotate further in relation to the work vehicle 100.

According to some aspects of the present disclosure, therefore, the tool assembly 200 includes the tilt locking latch 250, as illustrated in FIGS. 5A through 5C. As shown in FIGS. 5A through 5C, the tilt locking latch 250 includes a lock plate 258 that selectively engages the mounting post 254 to prevent the lateral movement of the mounting post 254 within the tilt track 256 (and thus also prevents the tilt of the tool frame 202 relative to the tilt mount 252). The lock plate 258 can, in some examples, be secured to the tilt mount 252 by a bolt 260 that extends through an aperture in the lock plate 258 and engages with a corresponding socket in the tilt mount 252.

In some examples, the lock plate 258 can rotate about the bolt 260 to move between an engaged position, in which it contacts the mounting post 254 and prevents the mounting post 254 from laterally traversing the tilt track 256 (and thus prevents the rotation of the tool frame 202 relative to the tilt mount 252). In such examples, the tilt locking latch 250 can also include a lock pin 262 that can be selectively introduced into an aligned pair of apertures, including a first lock aperture in the lock plate 258 and a second lock aperture in the tilt mount 252, to lock the lock plate 258 in position relative to the bolt 260 and the tilt mount 252, and more particularly, to lock the lock plate 258 into the engaged position. Advantageously, this configuration allows the lock plate 258 to be selectively engaged with and disengaged from the mounting post 254 to disable and enable the tilt of the tool frame 202 relative to the tilt mount 252.

It will be appreciated that the tilt lock mechanism disclosed herein allows the roller to be placed in a fixed position. Advantageously this capacity facilitates assembly of the tool assembly 200 and its attachment to the work vehicle 100. Additionally, this allows the tool assembly 200 to be fixed in relation to the work vehicle 100 in preparation for transportation, which can improve the stability of the tool assembly 200 and accordingly reduces risk of damage to the tool assembly 200 during transport. It will also be appreciated that the tilt locking latch 250 allows the tool assembly 200 to be rotationally immobilized during servicing operations, including maintenance operations and replacement of the roller 204 (for example, swapping a padfoot roller for a smooth roller or vice versa) which increases the safety of such operations. Particularly by maintaining the roller drum in a locked configuration, the risk of unintended movement or misalignment is mitigated, thereby enhancing operational efficiency during these processes.

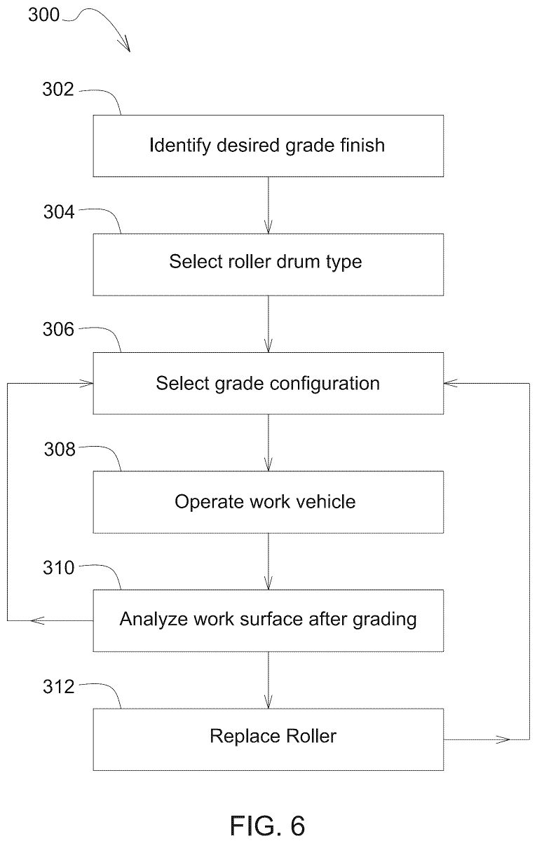

Also disclosed herein are examples of a method for grading a work site using a work vehicle 100 including the tool assembly 200 described above. An exemplary method for a grading operation 300 according to one aspect of the present disclosure is outlined in FIG. 6.

As shown in FIG. 6, the method for a grading operation 300 comprises identifying a desired grade finish for an operation, as shown in identification step 302. Generally, this step may be performed either by a vehicle operator, or by a site engineer and provided to the vehicle operator directly, or by program.

After the desired grade finish for an operation has been determined in identification step 302, the grading operation 300 further comprises selecting the type of roller 204 to be used with the tool assembly 200 during the grading operation 300, as shown in roller selection step 304. For example, if a comparatively greater quantity of compaction is required and a less precise finish is acceptable, a textured or “padfoot” roller 204 can be selected for use with the tool assembly 200 attached to the work vehicle 100. Likewise, if a comparatively more precise finish is required, but less compaction is needed, a smooth roller 204 can be selected for use with the tool assembly 200 attached to the work vehicle 100.

When both the desired grade finish and the appropriate roller selection are known, the grading operation 300 further comprises selecting the appropriate configuration for the blade assembly 210 of the tool assembly 200, as shown in blade configuration step 306. For example, if the tool assembly 200 includes a blade assembly 210 that is movable between a first position, a second position, and a third position, as described previously herein, the grading operation 300 can comprise determining, based at least in part on the desired grade finish identified in the identification step 302 and the roller selected in the roller selection step 304, the first position, the second position, or the third position can be selected for the blade assembly 210, depending on how much clearance between the blade edge 214 and the ground is desired in advance of roller compaction.

When the blade configuration for the blade assembly 210 of the tool assembly 200 and the roller selection for the roller 204 of the tool assembly 200 have been made in the roller selection step 304 and the blade configuration step 306, the grading operation 300 further comprises operating the work vehicle, as indicated in operation step 308. In the operation step 308, the work vehicle 100 is advanced along an assigned pathway for a combined grading and compaction operation, with the blade assembly 210 of the tool assembly 200 performing a grading operation to prepare the work site for a compaction operation, performed by the roller 204. As will be appreciated from the foregoing disclosure, because the tools are connected, a single pass of the work vehicle 100 may be sufficient to accomplish both operations.

According to one aspect of the present disclosure, the grading operation 300 may include one or more additional steps that can be optionally performed. For example, the grading operation 300 may further comprise analyzing the ground after the grading operation 300 has been completed to compare the resulting grade finish to the desired grade finish previously identified in the identification step 302, as illustrated in comparison step 310. Depending on the results of the comparison step 310, the grading operation 300 may further include selecting the configuration for the blade assembly 210 of the tool assembly 200 again (that is, repeating the blade configuration step 306), and repeating the operation of the work vehicle (that is, repeating the operation step 308 and the comparison step 310) with the new blade configuration.

In some examples, it may be desirable to conduct a grading and compaction operation using both a textured (that is, padfoot) roller and a smooth roller. As such, the grading operation 300 can also include a step of replacing the roller 204 with a different roller 204 (for example, switching from a padfoot roller 204 to a smooth roller 204 or from a smooth roller 204), as indicated in roller replacement step 312. Advantageously, this may allow a grading and compaction operation such as the grading operation 300 disclosed herein to benefit both from the high degree of compaction possible with a padfoot roller 204 and from the precise finish possible with a smooth roller 204. It will be further appreciated that, in such examples where the roller is replaced in the roller replacement step 312, the original position of the blade assembly 210 selected in the blade configuration step 306 may no longer be appropriate, so the grading operation 300 may in such examples also include re-selecting the blade configuration before operating the work vehicle with the new roller (that is, repeating the blade configuration step 306 and the operation step 308).

The grading operation 300 may also include at any point, but particularly following the blade configuration step 306, a step of verifying the position of the blade assembly 210 selected during the blade configuration step 306, using a position indicator assembly, such as the position indicator assembly 232 disclosed previously herein.

It will be appreciated that a combination of some or all of the foregoing features provide a tool assembly, such as the tool assembly 200 described herein, that combines a roller element, such as the roller 204 described herein with a blade, such as the blade assembly 210 described herein positioned ahead of the roller. Advantageously, this combination of features allows a single work vehicle, such as the work vehicle 100 described herein, to perform a grading operation and a rolling/compaction operation in a single pass of the tool package. It will be further appreciated that the adjustable positional relationship between the blade assembly 210 and the other components of the tool assembly 200 allows a user to select a desired grading parameter for any specified operation without changing the tool assembly 200 out for a different tool set. Thus, the tool assembly 200, as an attachment for a working machine, facilitates a single tool answer to the problem of work operations combining grading and compaction components.

Thus, although there have been described particular embodiments of the present invention of a new and useful ATTACHMENT FOR A WORKING MACHINE it is not intended that such references be construed as limitations upon the scope of this invention except as set forth in the following claims.

What is claimed is:

1. A tool assembly for a work vehicle comprising:
a tool frame;
a roller rotationally mounted to the tool frame for compacting a granular material; and
a blade assembly including a blade edge and being adjustably attached to the tool frame and pivotable around a pivot between a first configuration and a second configuration;
wherein when the blade assembly is in the first configuration, the blade edge is positioned a height relative to the ground and when the blade assembly is in the second configuration, the blade edge is positioned a second height relative to the ground, wherein the second height is greater than the first height.

2. The tool assembly of claim 1, further comprising an adjustable connector releasably securing the blade assembly to the tool frame and configured to retain the blade assembly in the first configuration or the second configuration.

3. The tool assembly of claim 1, wherein the blade assembly is removably attached to the tool frame.

4. The tool assembly of claim 2, wherein the adjustable connector comprises:
a first adjustment aperture extending through the blade assembly, a second adjustment aperture extending through the blade assembly and spaced apart from the first adjustment aperture, and a tool frame aperture extending through the tool frame; and
a bolt or pin configured to removably extend through either the first adjustment aperture or the second adjustment aperture and through the frame aperture,
wherein when the bolt or pin extends through the first adjustment aperture and the frame aperture, the blade assembly is retained in the first configuration and when the bolt or pin extends through the second adjustment aperture and the frame aperture, the blade assembly is retained in the second configuration.

5. The tool assembly of claim 4, wherein a reference axis is defined extending from the pivot to the first aperture, a tilt axis is defined extending from the pivot to the pin, and a tilt angle is defined between the reference axis and the tilt axis, such that the tilt angle has a first value when the blade assembly is in the first configuration and a second value when the blade assembly is in the second configuration, and the second value is greater than the first value.

6. The tool assembly of claim 5, wherein the first value ranges from 0 degrees to 1 degree and the second value ranges from 9 degrees to 11 degrees.

7. The tool assembly of claim 5, wherein the adjustable connector further comprises a third adjustment aperture extending through the blade assembly, the bolt or pin is further configured to removably extend through the third adjustment aperture and through the frame aperture to secure the blade assembly in a third configuration, the tilt angle has a third value when the blade assembly is in a third configuration, and the third value is greater than the second value.

8. The tool assembly of claim 7, wherein the third angle ranges from 19 degrees to 21 degrees.

9. The tool assembly of claim 5, further comprising an indicator arm mounted to the tool frame and a position gauge mounted to the blade assembly and movable relative to the indicator arm, wherein the indicator arm and the position gauge are configured to visibly indicate the configuration of the blade assembly.

10. The tool assembly of claim 1, wherein the blade assembly is further rotatable about the pivot to a third configuration and when the blade assembly is in the third configuration the blade edge is positioned a third height relative to the ground, wherein the third height is greater than the second height.

11. The tool assembly of claim 1, further comprising a tilt locking latch configured to engage with the roller to prevent tilting of the roller relative to the ground.

12. The tool assembly of claim 11, wherein the tilt locking latch comprises:
a lock pin; and
a lock plate comprising a lock aperture configured to receive the lock pin, the lock plate configured to releasably secure the roller against the tool frame,
wherein when the lock pin is received in the lock aperture, the lock pin secures the lock plate to the tool frame.

13. The tool assembly of claim 1, wherein the roller is a smooth drum roller.

14. The tool assembly of claim 1, wherein the roller is a padfoot drum roller.

15. A work vehicle comprising the tool assembly of claim 1.

16. A method for a grading operation at a work site using a work vehicle including a tool assembly having a roller and a blade assembly, wherein the blade assembly is movable between a first configuration, a second configuration, and a third configuration, the method comprising:
identifying a desired grade finish for the grading operation;
selecting between a smooth drum roller and a padfoot drum roller based on the desired grade finish for the grading operation;
selecting between the first configuration, the second configuration, and the third configuration for the blade assembly depending on the desired grade finish and the drum roller selected;
operating the work vehicle at the work site to grade the ground according to the desired grade finish for the grading operation.

17. The method of claim 16, further comprising:
analyzing, by a machine operator, the ground after the grading operation has been finished, and comparing a resulting grade finish to the desired grade finish, and;
depending on the comparison of the resulting grade finish to the desired grade finish, repeating selecting between the first configuration, the second configuration, and the third configuration for the blade assembly.

18. The method of claim 16, further comprising:
switching between the padfoot drum roller and the smooth drum roller; and
repeating selecting between the first configuration, the second configuration, and the third configuration for the blade assembly.

19. The method of claim 16, wherein the tool assembly further includes an indicator that indicates the configuration of the blade assembly and wherein the method further includes a step of verifying the configuration of the blade assembly using the indicator.

20. A work vehicle comprising:
a tool assembly including a tool frame, a roller rotatably mounted to the tool frame, and a blade assembly including a blade edge and being adjustably attached to the tool frame and rotatable around a pivot between a first configuration, a second configuration, and a third configuration; and
a locking mechanism configured to secure the blade assembly in the first configuration, the second configuration, or the third configuration,
wherein the blade edge extends at an angle relative to the ground and wherein when the blade assembly is in the first configuration, the angle has a first value, when the blade assembly is in the second configuration, the angle has a second value, and when the blade assembly is in the third configuration, the angle has a third value, and
wherein the second value is greater than the first value and the third value is greater than the second value.
